(19) United States
(12) Patent Application Publication
(10) Pub. No.: US 2010/0283916 A1
(43) Pub. Date: Nov. 11, 2010

(54) TV Receiver, Associated TV System and TV Control Method

(75) Inventors: Ching-Shu Yen, Hsinchu Hsien (TW); Hung-Chi Huang, Hsinchu Hsien (TW)

Correspondence Address: WPAT, PC;INTELLECTUAL PROPERTY ATTORNEYS, 7225 BEVERLY ST., ANNANDALE, VA, 22003, US

(73) Assignee: MStar Semiconductor, Inc., Hsinchu Hsien (TW)

(21) Appl. No.: 12/644,945

(22) Filed: Dec. 22, 2009

(30) Foreign Application Priority Data
May 6, 2009 (TW) 098114962

(51) Int. Cl. H04N 5/44; G06F 7/04

(52) U.S. Cl. 348/734; 340/5.83; 348/E05.096

(57) ABSTRACT

A television (TV) receiver includes a wireless module, a database, a user identification module and a channel selecting module. The wireless module receives a wireless signal carrying an identification (ID) data of a specific user. The database stores channel selecting information corresponding to a plurality of users. The user identification module retrieves channel selecting information corresponding to the specific user from the database according to the ID data of the specific user. The channel selecting module selects a channel according to the channel selecting information corresponding to the specific user. An associated TV system and TV control method are also provided.

CROSS REFERENCE TO RELATED PATENT APPLICATION

This patent application is based on Taiwan, R.O.C. patent application No. 098114962 filed on May 6, 2009.

### FIELD OF THE INVENTION

The present invention relates to a television (TV) control based on user habits, and more particularly, to a TV receiver, an associated system and a TV control method.

### BACKGROUND OF THE INVENTION

In the prior art, a TV remote controller usually has a button for returning from a currently viewed channel to a previously viewed channel, and a user may also press the button to switch between the two channels. However, this simple design can not meet requirements of most users.

More particularly, in order to immediately switch to a desired channel, the user has to memorize numbers of certain favorite channels. Yet, with respect to a user without a good memory, such prerequisite of memorizing the numbers of the favorite channels is inconvenient even to an extent of infeasible, such that the user is forced to continuously switch channels one after another to find a favorite channel. There are some remote controllers that provide other buttons to solve the foregoing problem. However, it is still impractical for a family having several members when each of the members has his own favorite channels.

As mentioned above, the design of the prior art is too simple and the available solution is impractical to meet user requirements. Therefore, the conventional technology needs to be improved.

### SUMMARY OF THE INVENTION

One object of the present invention is to provide a TV receiver, an associated TV system, and a TV control method to solve the foregoing problem.

A TV receiver is provided according to a preferred embodiment of the present invention. The TV receiver comprises a wireless module, a database, a user identification module, and a channel selecting module. The wireless module receives a wireless signal carrying an identification (ID) data of a specific user. The database stores channel selecting information corresponding to a plurality of users. The user identification module retrieves channel selecting information of the specific user from the database according to the ID data of the specific user. The channel selecting module selects a channel according to the channel selecting information corresponding to the specific user.

An associated TV system corresponding to the foregoing TV receiver is provided according to an embodiment of the present invention. The associated TV system comprises a remote controller, a wireless module, a database, a user identification module, and a channel selecting module. The remote controller transmits a wireless signal carrying an ID data of a specific user. The wireless module receives the wireless signal. The database stores channel selecting information corresponding to a plurality of users. The user identification module retrieves channel selecting information corresponding to the specific user from the database according to the ID data of the specific user. The channel selecting module selects a channel according to the channel selecting information corresponding to the specific user. More particularly, the remote controller comprises an identification module and a wireless module. In one embodiment, the identification module is implemented with a fingerprint identification module. The identification module generates the ID data, and the wireless module of the remote controller transmits the wireless signal.

An associated TV control method corresponding to the foregoing TV receiver is provided according to an embodiment of the present invention. The TV control method comprises receiving a wireless signal carrying an ID data of a specific user; retrieving channel selecting information corresponding to the specific user according to the ID data of the specific user; and selecting a channel according to the channel selecting information corresponding to the specific user.

### BRIEF DESCRIPTION OF THE DRAWINGS

FIG. 1 is a schematic diagram of a TV system in accordance with a first embodiment of the present invention.

FIG. 2 is a schematic diagram of a TV control method in accordance with an embodiment of the present invention.

FIG. 3 is a flowchart of a TV control method in accordance with an embodiment of the present invention.

FIG. 4 is a schematic diagram of a database in accordance with an embodiment of the present invention.

FIG. 5 is a schematic diagram of a TV system in accordance with a second embodiment of the present invention.

### DETAILED DESCRIPTION OF THE PREFERRED EMBODIMENT

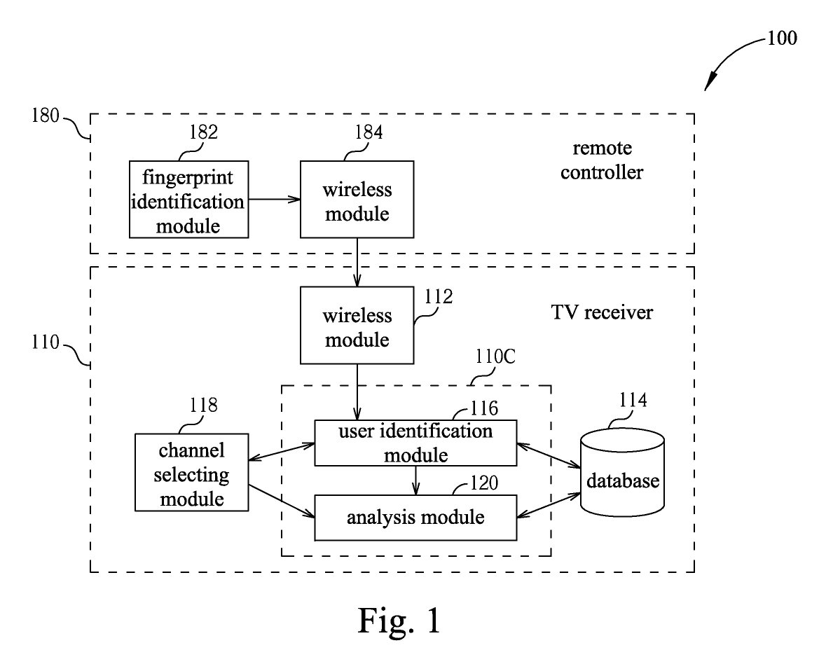

Refer to FIG. 1 showing a schematic diagram of a TV system 100 in accordance with a first embodiment of the present invention. The TV system 100 comprises a TV receiver 110 and a remote controller 180. The TV receiver 110 comprises a wireless module 112, a database 114, a user identification module 116, a channel selecting module 118, and an analysis module 120. The remote controller 180 comprises a fingerprint identification module 182 and a wireless module 184. According to this embodiment, the TV receiver 110 is a set-top box (STB) such as a digital TV STB; however, this example shall not be construed as limiting the present invention. According to a variation of this embodiment, the TV receiver 110 is built inside a TV. For example, the TV system 100 is a liquid crystal digital (LCD) TV system or a plasma TV system. According to another variation, the TV receiver 110 is built inside a laptop, a pocket computer, a personal digital assistant (PDA), or a multi-functional mobile phone.

For example, the user identification module 116 and the analysis module 120 are realized through a control circuit 110C by executing a specific program code. Under such condition, the user identification module 116 and the analysis module 120 represent software modules of the specific code, so that the control circuit 110C is physically the user identification module 116 and the analysis module 120. However, the example is disclosed to gain a better understanding of the present invention, and it shall not be construed as limiting the invention. According to a variation of this embodiment, the specific code is a firmware code. The database 114 is built inside a storage device such as a hard disk or a memory.

According to this embodiment, the database 114 stores channel selecting information corresponding to a plurality of users. The analysis module 120 respectively gathers statistics on users' viewing habits, and in particular, with the aid of the channel selecting module 118, counts the numbers of times of viewing respective channels by the respective users, so as to obtain a distribution of the numbers of times of viewing the channel. More specifically, when a user views a program, the analysis module 120 learns an identity of the current user from the user identification module 116, and gathers statistics on viewing habits of the user. In particular, from the channel selecting module 118, the analysis module 120 gathers and counts the numbers of times of viewing respective channels by the respective users, so as to obtain a distribution of the numbers of times of viewing the channel. Thus, corresponding to the users, the analysis module 120 respectively generates channel selecting information to be stored into the database 114. According to this embodiment, the analysis module 120 updates the channel selecting information stored in the database 114 at all times or on a predetermined schedule. In a preferred embodiment, the analysis module 120 further gathers statistics on channels viewed by each user at different time points.

Upon detecting a touch from a specific user, the remote controller 180 transmits an ID data of the specific user to the TV receiver 110. After having received the ID data, the TV receiver selects a corresponding channel, i.e. channel selection is performed. In this embodiment, the ID data comprises a data representing fingerprint information of the specific user. For example, the ID data is a group of 16-bit codes or a bit string.

For example, names of the users comprises “Neo”, “Trinity”, “Morris”, and “Bob”, fingerprint information of the users are respectively “a098fjkx”, “adsvk93”, “9839xkss”, and “akavkek2”, and supposing the specific user currently holding the remote controller 180 is “Neo”. In response to a touch from “Neo”, the fingerprint identifying module 182 generates the ID data “098fjkx” of the specific user “Neo”, and the wireless module 184 correspondingly transmits a wireless signal including the ID data “098fjkx”. The wireless module 112 of the TV receiver receives the wireless signal carrying the ID data “098fikx” of the specific user “Neo” from the wireless module 184. In addition, in response to the wireless signal received by the wireless module 112, the user identification module 116 retrieves channel selecting information corresponding to the user “Neo” from the database 114. Accordingly, the channel selecting module 118 selects a corresponding channel.

According to this embodiment, the wireless modules 112 and 184 are infrared control modules, and the foregoing wireless signal is an infrared signal. More particularly, the wireless module 184 is an infrared transmitting module, and the wireless module 112 is an infrared receiving module. However, this example is disclosed to gain a better understanding of the present invention, and it shall not be construed as limiting the present invention. According to a variation of this embodiment, the wireless modules 112 and 184 are other types of wireless transmitting/receiving modules. For example, the wireless modules 112 and 184 are Bluetooth communication modules or radio frequency (RF) communication modules.

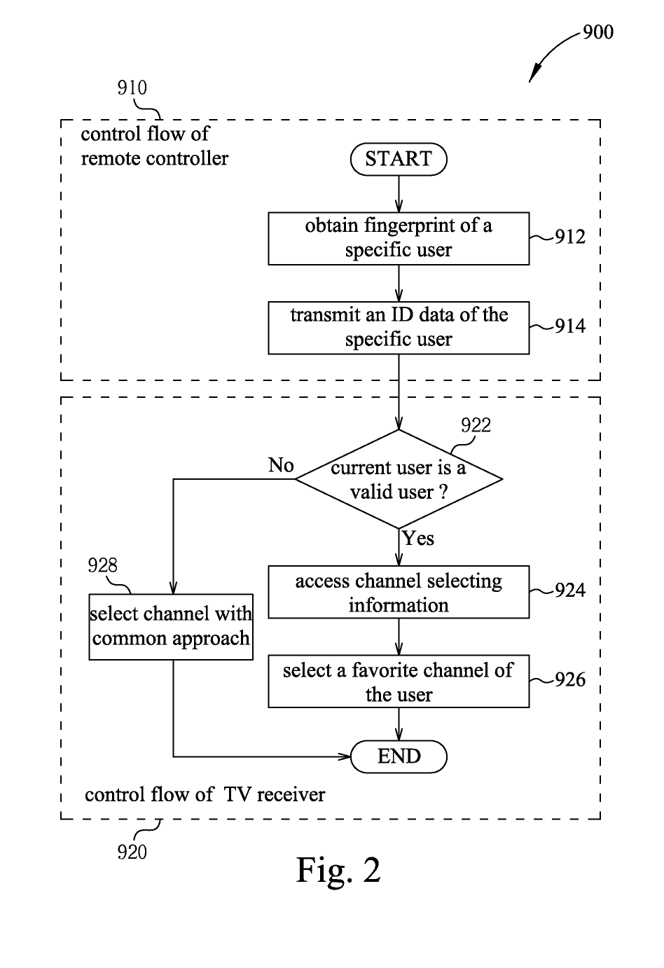

FIG. 2 is a schematic diagram illustrating steps of a TV control method 900 in accordance with an embodiment of the present invention. The TV control method 900 is applied to the TV system 100 illustrated in FIG. 1. The TV control method 900 comprises a control flow 910 of a remote controller and a control flow 920 of a TV receiver, which respectively correspond to the remote controller 180 and the TV receiver 110 illustrated in FIG. 1. The TV control method 900 is described below.

In Step 912, the fingerprint identification module 182 identifies a fingerprint of a specific user. For example, when the specific user “Neo” currently holds the remote controller 180, in response to a touch from the specific user “Neo”, the fingerprint identification module 182 identifies the fingerprint of “Neo” and generates an ID data “a098fjkx” corresponding to “Neo”.

In Step 914, the wireless module 184 transmits an ID data of the specific user, and more particularly transmits a wireless signal carrying the ID data “a098fjkx” when the specific user is “Neo”.

In Step 922, the user identification module 116 determines whether the current user is a valid user. More particularly, the user identification module 116 searches the database 114 according to the ID data received from the remote controller 180, so as to determine whether the current user is the valid user. When the answer is yes, Step 924 is performed; otherwise, Step 928 is performed. For example, when the user identification module 116 searches the database 114 according to the ID data “098fjkx”, and determines that the ID data “098fjkx” corresponds to the user “Neo”, Step 924 is performed.

In Step 924, the user identification module 116 accesses channel selecting information. For example, the user identification module 116 retrieves channel selecting information corresponding to the specific user from the database 114 according to the ID data, and transmits the channel selecting information to the channel selecting module 118.

In Step 926, the channel selecting module 118 selects a favorite channel of the user, and more particularly selects the favorite channel according to the channel selecting information of the specific user. For example, when the specific user is “Neo”, the channel selecting module 118 selects a channel according to a favorite channel (channel 5 in this embodiment) of the specific user “Neo”. According to this embodiment, channel selecting information of each of the users comprises a favorite channel. For example, when the channel selecting information from the latest statistics of the database 114 indicates the favorite channel of the user “Neo” is channel 5, the channel selecting module 118 accordingly learns that the favorite channel of the user “Neo” is channel 5 and thus selects channel 5. However, this example is disclosed to gain a better understanding of the present invention, and it shall not be construed as limiting the present invention. According to a variation of this embodiment, the channel selecting information of each user comprises a favorite channel or a plurality of favorite channels each having a priority. For example, when the channel selecting information from the latest statistics of the database 114 indicates the favorite channels of the user “Neo” is channel 5, channel 10, channel 15, and channel 20 in sequence; the channel selecting module 118 activates the TV receiver 110 to display the numbers of the favorite channels in the priority sequence so that the user can select one of the favorite channels. According to a variation of this embodiment, when a reply of the user is not obtained within a predetermined time, e.g., several seconds, the channel selecting module 118 directly determines that a favorite channel having a highest priority, e.g., channel 5, is the favorite channel.

In Step 928, the channel selecting module 118 selects a channel according to a common approach; however, this example is disclosed to gain a better understanding of the present invention, and it shall not be construed as limiting the present invention. According to a variation of this embodiment, the database 114 further stores channel selecting information corresponding to a general user. Therefore, the channel selecting module 118 selects a channel according to the channel selecting information corresponding to the general user.

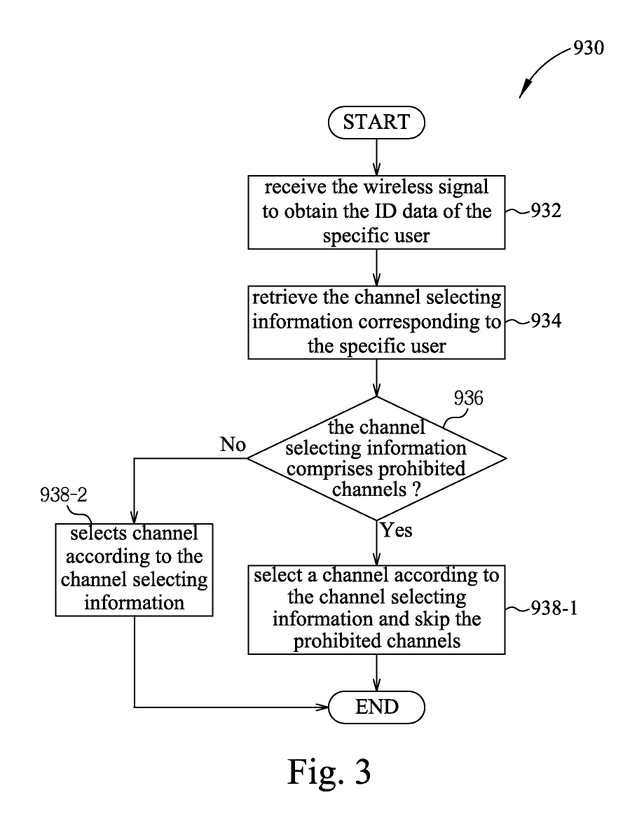

FIG. 3 is a flowchart of a TV control method in accordance with an embodiment of the present invention. More particularly, FIG. 3 is a flowchart of the control flow 930 of the TV receiver 110, and this embodiment is a variation of the embodiment illustrated in FIG. 2. According to this embodiment, channel selecting information of at least one user may further comprise one or more channel prohibited from viewing. For example, when the user “Neo” is the head of a family, he has an authority for defining the TV system 100, such as defining a prohibited channel with respect to each member of the family. In addition to defining a prohibited channel for an underage member, the user “Neo” may also define an unwished channel as a default prohibited channel for the entire family.

In Step 932, the TV receiver 110 receives the wireless signal via the wireless module 112 to obtain the ID data of the specific user.

In Step 934, the user identification module 116 retrieves the channel selecting information corresponding to the specific user. More particularly, the user identification module 116 retrieves the channel selecting information corresponding to the specific user from the database 114 and provides the obtained channel selecting information to the channel selecting module 118. For example, when the specific user is “Neo”, the user identification module 116 searches the database 114 for the ID data carried by the wireless signal, and accordingly retrieves the channel selecting information corresponding to the user “Neo”.

In Step 936, after receiving the channel selecting information provided by the user identification module 116, the channel selecting module 118 learns whether the channel selecting information comprises prohibited channels. More particularly, after receiving the channel selecting information provided by the user identification module 116, the channel selecting module 118 learns whether the channel selecting information comprises a prohibited channel list. When the channel selecting information comprises prohibited channels, Step 938-1 is performed; otherwise, Step 938-2 is performed. For example, after Step 934 of retrieving the channel selecting information corresponding to the user “Neo” by the user identification module 116 and providing the channel selecting information to the channel selecting module 118 is performed, the channel selecting module 118 learns that the channel selecting information comprises prohibited channels 54 and 55, and Step 938-1 is to be performed.

In Step 938-1, the channel selecting module 118 selects a channel according to the channel selecting information and skips the prohibited channels during a channel switching. More particularly, when the user “Neo” activates the TV receiver 110 to select his favorite channels, under control of the channel selecting module 118, Step 924 and Step 926 are performed. Once the user “Neo” switches channels one after another, channels 54 and 55 are skipped. For example, when switching from channel 40 and upwards, channel 53 directly jumps to channel 56 without going through channels 54 and 55. When switching from channel 70 and downwards, channel 56 directly jumps to channel 53 without going through channels 55 and 54.

In Step 938-2, the channel selecting module 18 selects a channel according to the channel selecting information. For example, when the specific user activates the TV receiver 110 via the remote controller 180 to select his favorite channels, under control of the channel selecting module 118. Step 924 and Step 926 are performed. Since no prohibited channel exists under this condition, once the specific user switches channels one after another, the channel is switched upwards and downwards in a normal numerical order.

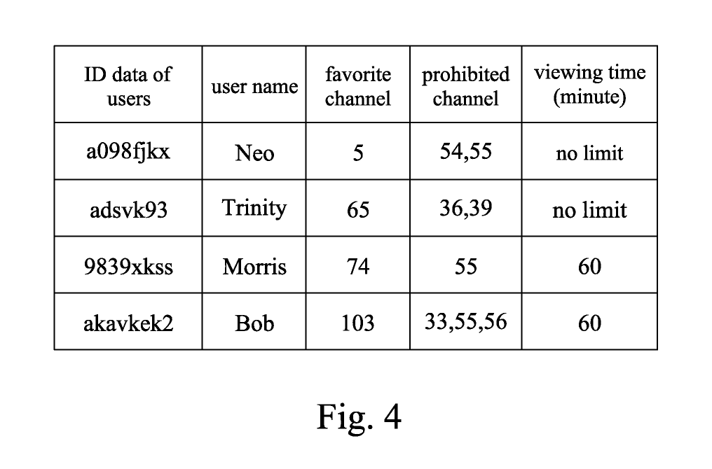

FIG. 4 is a schematic diagram of the database 114 in accordance with an embodiment of the present invention, and this embodiment is a variation of the first embodiment. In addition to a fingerprint identification data of a user, a name of a user, a favorite channel, a prohibited channel, the database 114 according to this embodiment further comprises a viewing time, i.e., a time limit that a TV is allowed to be viewed. This embodiment is similar to the foregoing embodiments, and details thereof shall not be described for brevity.

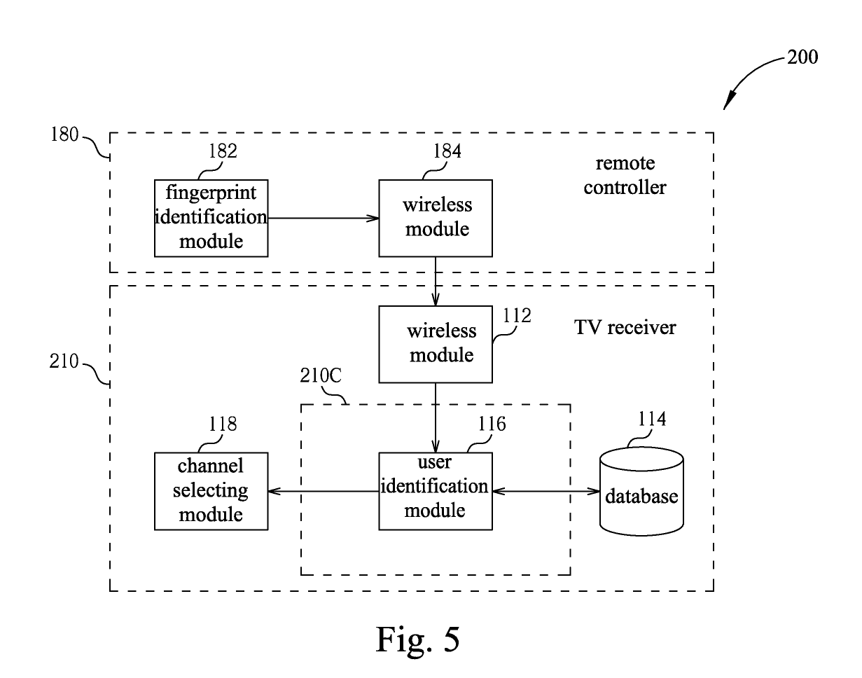

FIG. 5 is a schematic diagram of a TV system 200 in accordance with a second embodiment of the present invention, and this embodiment is a variation of the first embodiment. The TV system 200 according to this embodiment does not have functions that the analysis module 120 corresponds to. According to this embodiment, the channel selecting information corresponding to the users is respectively generated by recording channels that the users viewed at a previous viewing. More particularly, the channel selecting information corresponding to the users respectively has predetermined values. Once the specific user views a certain channel, a favorite channel of the channel selecting information corresponding to the specific user is updated. This embodiment is similar to the foregoing embodiments, and details thereof shall not be described for brevity.

According to variation of this embodiment, in the database 114, the channel selecting information corresponding to the users is correspondingly defined by the users. This embodiment is similar to the foregoing embodiments, and details thereof shall not be described for brevity.

According to a variation of the first and second embodiments, channel selecting information corresponding to the users may be generated by a first generating mode of gathering statistics on users' viewing habits, a second generating mode of being defined by the users, or a third generating mode of recording channels viewed at a previous viewing. The users are given the three options above to determine to which of the three generating modes to use. This embodiment is similar to the foregoing embodiments, and details thereof shall not be described for brevity.

Compared to the prior art, a TV receiver, an associated TV system and a TV control method according to embodiments of the present invention are capable of automatically providing a favorite channel to every individual within a group of users, and this humanization and personalized service is not jeopardized by other user viewing habits. Therefore, according to the present invention, an excellent viewing experience is ensured for every user.

Another advantage of the present invention is that, a TV receiver, an associated TV system and a TV control method according to embodiments of the present invention are capable of defining prohibited channels for any user from a group of users while authorities of other users are not influenced.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A TV receiver, comprising:
a wireless module, for receiving a wireless signal carrying an identification data of a first user;
a database, for storing a first channel selecting information corresponding to the first user and a second channel selecting information corresponding to a second user;
a user identification module, for retrieving the first channel selecting information from the database according to the identification data of the first user; and
a channel selecting module, for selecting a channel according to the first channel selecting information.

2. The TV receiver as claimed in claim 1, wherein the wireless module is an infrared control module, and the wireless signal is an infrared signal.

3. The TV receiver as claimed in claim 1, wherein the identification data comprises fingerprint information of the first user.

4. The TV receiver as claimed in claim 1, wherein the first channel selecting information in the database comprises a favorite channel or a plurality of favorite channels each having a priority.

5. The TV receiver as claimed in claim 1, wherein the first channel selecting information in the database comprises a prohibited channel.

6. The TV receiver as claimed in claim 1, further comprising an analysis module for respectively gathering information of channel selection by the first user from the channel selecting module to generate the first channel selecting information, and for storing the generated first channel selecting information into the database.

7. The TV receiver as claimed in claim 1, wherein the first channel selecting information and the second channel selecting information in the database are defined respectively by the first user and the second user.

8. ATV system, comprising:
a remote controller, for transmitting a wireless signal carrying an identification data of a first user;
a first wireless module, for receiving the wireless signal;
a database, for storing a first channel selecting information corresponding to the first user and for storing a second channel selecting information corresponding to a second user;
a user identification module, for retrieving the first channel selecting information from the database according to the identification data of the first user; and
a channel selecting module, for selecting a channel according to the first channel selecting information.

9. The TV system as claimed in claim 8, wherein the remote controller comprises:
a fingerprint identifying module, for generating the identification data; and
a second wireless module, for transmitting the wireless signal.

10. The TV system as claimed in claim 8, wherein the first channel selecting information in the database comprises a favorite channel or a plurality of favorite channels each having a priority.

11. The TV system as claimed in claim 8, wherein the first channel selecting information in the database comprises a prohibited channel.

12. The TV system as claimed in claim 8, further comprising an analysis module for respectively gathering information of channel selection by the first user, from the channel selecting module, to generate the first channel selecting information, and for storing the generated first channel selecting information into the database.

13. The TV system as claimed in claim 8, wherein the first channel selecting information and the second channel selecting information in the database are defined respectively by the first user and the second user.

14. A TV control method, comprising:
receiving a wireless signal carrying an identification data of a first user;
retrieving a first channel selecting information corresponding to the identification data of the first user; and
selecting a first channel according to the first channel selecting information corresponding to the identification data of the first user.

15. The TV control method as claimed in claim 14, wherein the wireless signal is an infrared signal.

16. The TV control method as claimed in claim 14, wherein the identification data comprises fingerprint information of the first user.

17. The TV control method as claimed in claim 14, further comprising:
storing the first channel selecting information and a second channel selecting information corresponding to the first user and a second user, respectively, into a database.

18. The TV control method as claimed in claim 17, wherein the first channel selecting information in the database comprises a favorite channel or a plurality of favorite channels each having a priority.

19. The TV control method as claimed in claim 17, wherein the first channel selecting information in the database comprises a prohibited channel.

20. The TV control method as claimed in claim 17, further comprising:
gathering information of channel selection by the first user to generated the first channel selecting information.
